(19) United States
(12) Patent Application Publication
(10) Pub. No.: US 2007/0233929 A1
(43) Pub. Date: Oct. 4, 2007

(54) Computer system and control method thereof

(75) Inventor: Sung-shik Baik, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon (KR)

(21) Appl. No.: 11/653,970

(22) Filed: Jan. 17, 2007

(30) Foreign Application Priority Data
Feb. 14, 2006 (KR) 2006-14239

(51) Int. Cl. G06F 13/00

(52) U.S. Cl. 710/303

(57) ABSTRACT

A computer system, including a main body, a docking station, a display part, a first video processing part provided in the main body to output first video data, a second video processing part provided in the docking station to output second video data that is different from the first video data, and a controller to selectively control the first video processing part or the second video processing part to output the first video data or the second video data, respectively, to the display part depending on whether the main body is docked on the docking station.

### CROSS-REFERENCE TO RELATED APPLICATIONS

This application claims the benefit of Korean Patent Application No. 2006-14239, filed Feb. 14, 2006, in the Korean Intellectual Property Office, the disclosure of which is incorporated herein by reference.

### BACKGROUND OF THE INVENTION

1. Field of the Invention

Aspects of the present invention relate to a computer system and a control method thereof, and, more particularly, to a computer and a control method thereof, which selects suitable video quality according to a user environment.

2. Description of the Related Art

As illustrated in FIG. 1, a computer system 10 generally includes a display part 16 to employ a Liquid Crystal Display (LCD) panel, a Central Processing Unit (CPU) 11 to generally control the computer system 10, a video processing part 13 to convert predetermined video information into video data so that the display part 16 is able to display the video data thereon, a memory 14 such as a Double-Data-Rate Dynamic Random Access Memory(DDR DRAM) to store data processed by the CPU 11, the video processing part 12, etc., and an memory Controller Hub (MCH) 12 to interface between an Input/Output Controller Hub (ICH) 15 and the CPU 11 to allow for data transmission therebetween. The ICH 15 provides an interface between an Input/Output device (not shown), such as a modem, a hard disk drive, a Universal Serial Bus (USB) port, etc. The MCH 12 allows for data transmission therebetween.

The video processing part 13 may include a circuit device (e.g., a graphic card, a video card, a display adapter, a video adapter, and/or a graphic adapter). The video processing part 13 may further be realized together with the MCH 12 as a chipset (hereinafter, referred to as “an internal video chip”). Alternatively, the video processing part 13 may be realized as a separate circuit device (hereinafter, referred to as “an external video chip”), such as a graphics card, that is equipped in an extension slot (not shown), such as an Accelerated Graphics Port (APG) provided in the MCH 12.

Generally, as shown in Table 1, characteristic properties of the internal video chip and the external video chip are as follows:

TABLE 1

| | Internal Video Chip | External Video Chip |
|---|---|---|
| Video Quality | Low | High |
| Power Consumption | Small | Large |
| Heat Emission | Small | Large |
| Size | Small | Large |
| Portability | High | Low |

In particular, the internal video chip occupies a small area on a motherboard (not shown), emits little heat, has a simple operational configuration, and reduces production costs. However, the internal video chip provides low video quality. Conversely, the external video chip provides high-quality video quality. However, the external video chip occupies a relatively large area inside of the computer system 10, has low characteristic heat transmission, and has low characteristic portability due to its relative large size. Accordingly, a portable computer such as a laptop computer may employ the internal video chip because of the above-mentioned properties.

Recently, a demand for a user environment that displays a high-quality video for a 3-Dimension video game, a high-quality movie, and the like, has increased. Even though a user may prefer the portable computer to the desktop computer, he or she may have no choice but to select to use the desktop computer employing the external video chip to display a high-quality video as opposed to the portable computer employing the internal video chip to display limited-quality video.

### SUMMARY OF THE INVENTION

Accordingly, it is an aspect of the present invention to provide a computer system and a control method thereof which selects a suitable video quality according to a user environment. It is also another aspect of the present invention to provide a computer system and a control method which allows a user to select a portable computer or a desktop computer by meeting requirements for video quality depending on a user environment.

The foregoing and/or other aspects of the present invention are achieved by providing a computer system, including a main body, a docking station, a display part, a first video processing part provided in the main body to output first video data, a second video processing part provided in the docking station to output second video data that is different from the first video data, and a controller to selectively control the first video processing part or the second video processing part to output the first video data or the second video data, respectively, to the display part depending on whether the main body is docked on the docking station.

According to another aspect of the present invention, the controller controls the first video processing part to output the first video data to the display part when the main body is not docked on the docking station, and the second video processing part to output the second video data when the main body is docked on the docking station.

According to another aspect of the present invention, the computer system further comprises a user input part to receive a user's selection on one of the docking station and the main body, wherein the controller controls the first processing part to output the first video data from the main body, or the second processing part to output the second video data from the docking station to the display part, when the main body is docked on the docking station.

According to another aspect of the present invention, the second video data has larger amount data per unit time than the first video data.

According to another aspect of the present invention, the display part is provided in the main body.

According to another aspect of the present invention, the display part is connected to the docking station.

The foregoing and/or other aspects of the present invention are also achieved by providing a control method of a computer system including a main body, a docking station, and a display part, the method comprising: checking whether the main body is docked on the docking station; selectively processing first video data from the main body or second video data different from the first video data from the docking station, depending on a result of the checking; and outputting the processed first video data or the processed second video data to the display part.

According to another aspect of the present invention, the processing the first video data or the second video data comprises processing the first video data when the main body is not docked on the docking station, and processing the second video data when the main body is docked on the docking station.

According to another aspect of the present invention, the control method further comprises selecting the main body or the docking station when the main body is docked on the docking station, wherein the outputting the processed first video data or the processed second video data comprises outputting the first video data from the selected main body or the second video data from the selected docking station to the display part.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a configuration of a conventional computer system;

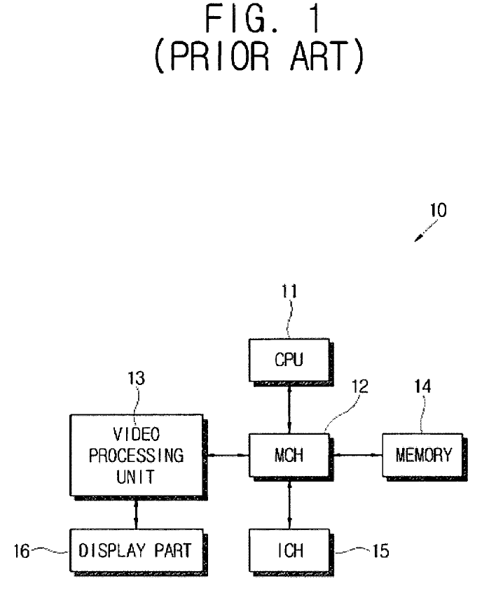

FIG. 2 is a perspective diagram of an outer appearance of a computer system according to a first embodiment of the present invention;

FIG. 3 is a block diagram of an inner configuration of the computer system according to the first embodiment of the present invention;

FIG. 4 is a flowchart of an operation of the computer system according to the first embodiment of the present invention; and

FIG. 5 is another block diagram of an inner configuration of a computer system according to a second embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

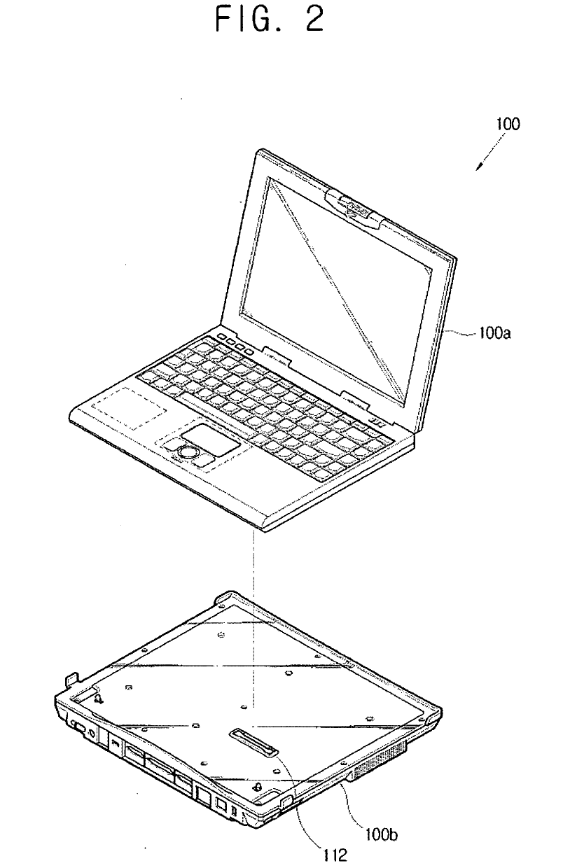

FIG. 2 is a perspective diagram of an outer appearance of a computer system 100 according to a first embodiment the present invention. As shown, the computer system 100 may be a portable computer such as laptop computer. The computer system 100 may include a main body 100a and a docking station 100b. The docking station 100b may be detachable from the main body 100a and vice versa.

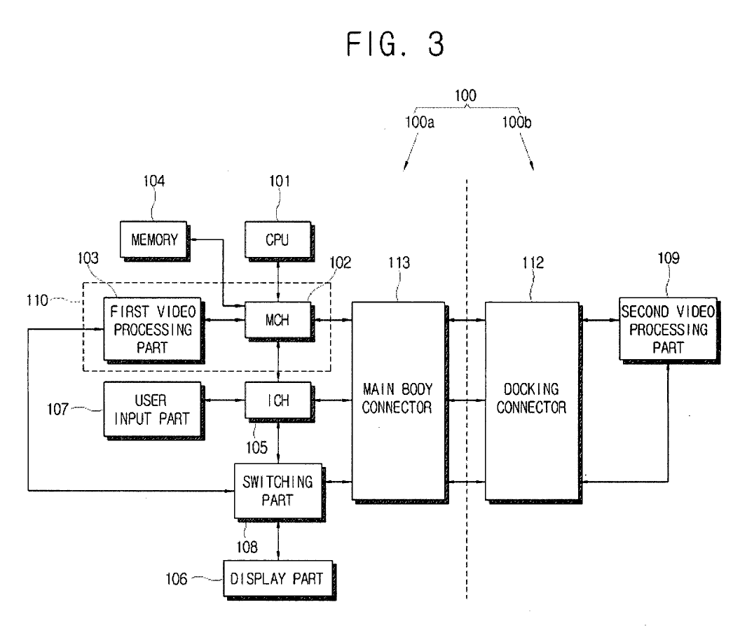

FIG. 3 is a block diagram of an inner configuration of the computer system 100 according to a first embodiment of the present invention. As illustrated therein, the computer system 100 includes a Central Processing Unit (CPU) 101, a Memory Controller Hub (MCH) 102, a first video processing part 103, a memory 104, an Input/Output Controller Hub (ICH) 105, a display part 106, a user input part 107, a switching part 108, and a second video processing part 109. While the CPU 101, the MCH 102, the first video processing part 103, the memory 104, the ICH 105, the display part 106, the user input part 107, and the switching part 108 are provided in the main body 100a, the second video processing part 109 is provided in the docking station 100b.

The CPU 101 executes a computer program to control the computer system 100. The memory 104 may include a Double-Data-Rate Dynamic Access Memory (DDR DRAM) to store data processed by the CPU 101, the first video processing part 103, and the second processing part 109, and the like. The MCH 102 acts as a host controller to provide an interface for the CPU 101, the first video processing part 103, the second video processing part 109, and the memory 104 and to allow for data transmission therebetween. Also, the MCH 102 interfaces with the CPU 101 and the ICH 105 to allow for data transmission therebetween.

As shown in FIG. 2, he docking station 100b includes a docking connector 112 to connect the second video processing part 109 and the MCH 102. At this time, the main body 100a includes a main body connector 113 at a location that corresponds to the location of the docking connector 112. The docking connector 112 is connected to the main body connector 113 to interface with the second video processing part 109 and the MCH 102 and to allow for data transmission therebetween. The ICH 105 includes a docking sensing pin (not shown) to sense whether the docking connector 112 is connected to the main body connector 113. The docking sensing pin of the ICH 105 is connected to one of the pins of the main body connector 113. Data transmission between the second video processing part 109 and the MCH 102 may be controlled according to a computer bus standard such as a PCI Express (PCIe).

The display part 106 displays video corresponding to video data processed by either the first video processing part 103 or the second video processing part 109. The display part 106 may employ an LCD panel and the like. A user may input information through the user input part 107. The user input part 107 may employ a keyboard, a mouse, and/or the like. The ICH 105 acts as an input/output controller to provide an interface between the MCH 102 and the user input part 107 and to allow for data transmission therebetween. A controller, according to embodiments of the present invention, may include the CPU 101, the MCH 102, and the ICH 103 as an example.

The first video processing part 103 and the second video processing part 109 each process predetermined video information. The first video processing part 103 and the second video processing part 109 then each convert the processed video information into video data so that the display part 106 is able to display the video data thereon. The first video processing part 103 and the second video processing part 109, respectively, may each be realized as a circuit device employing an integrated circuit (IC) (e.g., a graphics card, a video card, a display adapter, a video adapter, a graphics adapter, and the like) or another similar device.

The first video processing part 103 may be “an internal video chip.” Particularly, the first video processing part 103 may be realized as a chipset together with the MCH 12. The second video processing part 109 processes data more efficiently than the first video processing part 103. That is, the second video processing part 109 processes the data faster than the first video processing part 103 and/or processes a larger amount data per unit time than the first video processing part 103. As such, the second video processing part 109 outputs a higher quality of video than the first video processing part 103. Hereinafter, the data processed by the first video processing part 103 is also referred to as “first video data,” and the data processed by the second video processing part 109 is referred to as “second video data.”

The first video processing part 103 and the second video processing part 109 are connected to the display part 106 through the switching part 108. That is, the first data and the second data are transmitted to the display part 106 through the switching part 108. The ICH 105 controls the switching part 108 to provide an interface between the display part 106 and one of the first video processing part 103 and the second video processing part 109. The switching part 108 may include a logic circuit such as a multiplexer. The second video processing part 109 transmits and/or receives data to and/or from the switching part 108 through the docking connector 112 and the main body connector 113.

Depending on a selection of a user, the CPU 101 manages the ICH 105. According to the management of the ICH 105, the ICH 105 controls the switching part 108 to provide an interface between the display part 106 and one of either the first video processing part 103 or the second video processing part 109.

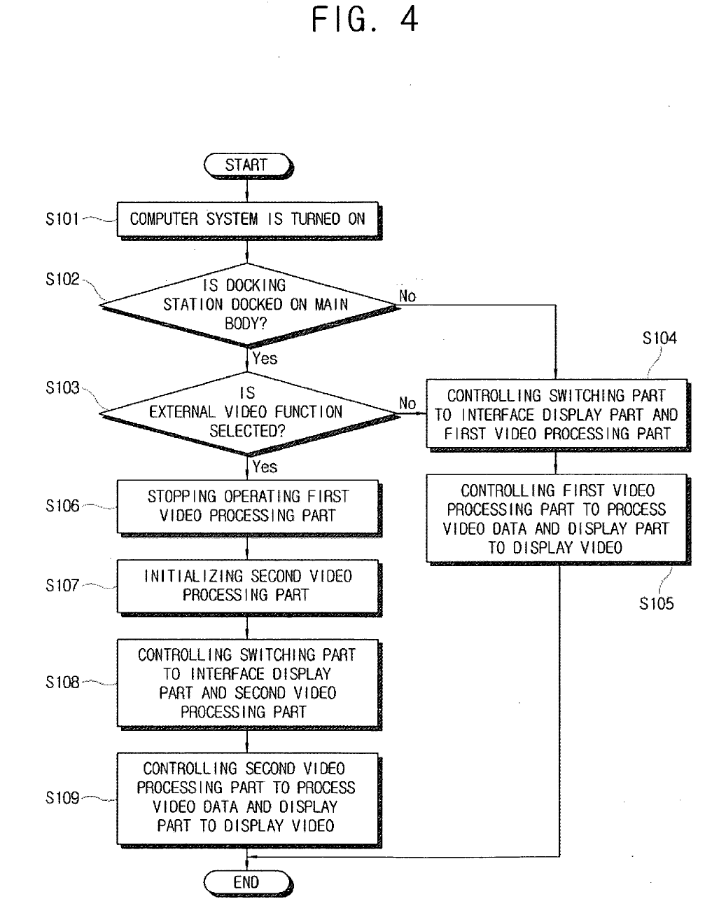

An operation of the computer system 100 will be in detail described with reference to FIG. 4. FIG. 4 is a flowchart of the operation of the computer system 100 according to the first embodiment of the present invention. First, when the computer system is turned on (S101), the CPU 101 senses whether the main body 100a is docked on the docking station 100b (S102). The CPU 101 determines whether the main body 100a is docked on the docking station 100b by checking whether the docking connector 112 is connected to the main body connector 113 through the docking sensing pin of the ICH 105.

As a result of operation S102, when the main body 100a is docked on the docking station 100b, the CPU 101 checks whether a user selects the second video processing part 109 (also referred to as “an external video function”) to process corresponding video (S103). The CPU 101 may receive selecting information on the external video function through the user input part 107. As a further result of operation S102, when the main body 100a is not docked on the docking station 100b, or as a result of operation S103, when a user does not select the external video function, the CPU 101 manages the ICH 105 to control the switching part 108 to provide an interface between the display part 106 and the first video processing part 103 (S104).

Then, the CPU 101 controls the first video processing part 103 to process video data and the display part 106 to display a video corresponding to the processed video data thereon (S105).

For example, when a user requires that the computer system 100 be portable or wants to use an application that requires low quality video (e.g., word processing, internet usage, and the like), the user may select the first video processing part 103 having high characteristic portability and low characteristic power consumption in consideration of size, weight, power consumption, and the like. Also, the user may at this point detach the main body 100a from the docking station 100b. Accordingly, the user improves the using efficiency of the computer system 100 and reduces unnecessary power consumption depending on a current user environment.

On the other hand, as a result of operation S102, when the main body 100a is docked on the docking station 100b, or as the result of operation S103, when a user selects the external video function, the CPU 101 stops the operation of the first video processing part 103 (S106), which is preset to be initially operated, and controls the ICH 105 to initialize the second video processing part 109 (S107). Then, the CPU 101 manages the ICH 105 to control the switching part 108 to provide an interface between the display part 106 and the second video processing part 109 (S108). Also, the CPU 101 controls the second video processing part 109 to process video data and the display part 106 to display a video corresponding to the processed video data thereon (S109).

For example, when a user uses the computer system 100 on a fixed surface such that a size, and a weight of the computer system 100 are relatively unimportant or wants to use an application that requires a high-quality video (e.g., a 3-dimension video game, a high-quality movie, and the like), the user may select the second video processing part 109, which is capable of processing the high quality video by having the main body 100a be docked on the docking station 100b. Accordingly, the user improves the using efficiency of the computer system 100 and meets his or her demand for the high quality video depending on the current user environment.

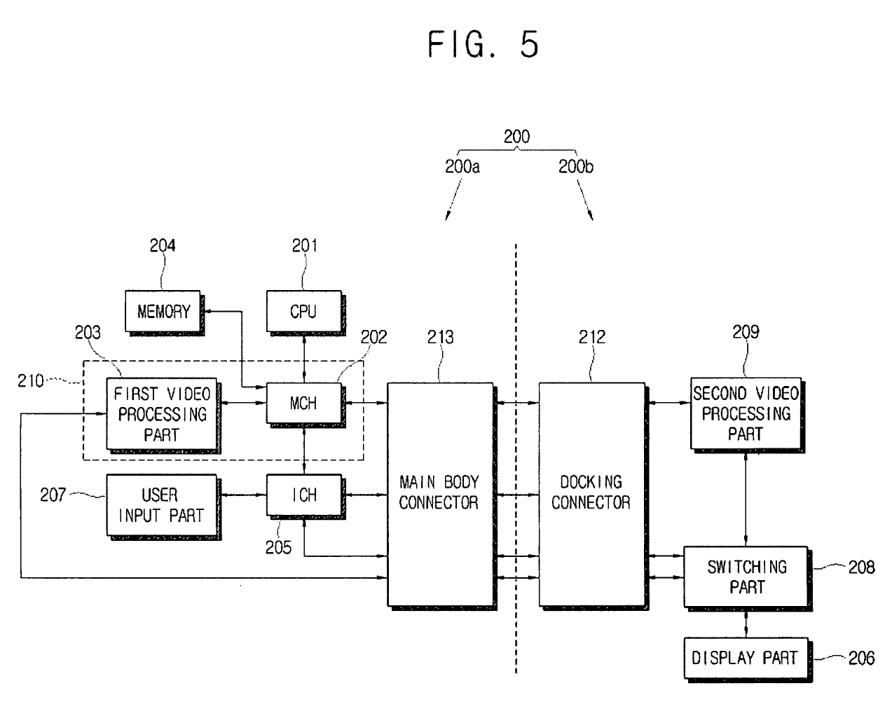

FIG. 5 is another block diagram of an inner configuration of a computer system 200 according to a second embodiment of the present invention. Similar descriptions of the computer system 200 as the computer system 100 according to the first embodiment will be omitted in the second embodiment of the present invention. As shown in FIG. 5, the computer system 200 includes a CPU 201, an MCH 202, a first video processing part 203, a memory 204, an ICH 205, a display part 206, a user input part 207, a switching part 208, and a second video processing part 209.

While the CPU 201, the MCH 202, the first video processing part 203, the memory 204, the ICH 205, and the user input part 207 are provided in a main body 200a, the second video processing part 209 and the switching part 208 are provided in a docking station 200b. The display part 206, which is physically separated from the computer system 200, may be connected to the docking station 200b of the computer system 200. Also, the display part 206 may include an LCD, a CRT (Cathode Ray Tube) device, a TV, and the like. The first video processing part 203, the ICH 205, and the switching part 208 may transmit or receive data to or from one another through a docking connector 212 and a main body connector 213.

As is described above, according to aspects of the present invention, the present invention improves the using efficiency of a computer system and meets a user's demand for a high quality video by controlling the computer system to suitably select one of an inside-provided display and a physically separated display depending on a user environment.

As is apparent from the above description, according to aspects of the embodiments of the present invention, there is provided a computer system and a control method thereof which select an optimum video quality depending on a user environment. That is, according to aspects of the embodiments of the present invention, there is provided a portable computer which maximizes the using efficiency thereof by allowing for a detaching of a main body thereof from a docking station thereof. The portable computer may use high portability and low power consumption when being used in applications that do not require high video quality. Further, when the main body is docked on the docking station, the computer may exhibit high video quality while having a structure that is not limited in terms of an outward appearance thereof or portability.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A computer system, comprising:
a main body;
a docking station;
a display part;
a first video processing part provided in the main body to output first video data;
a second video processing part provided in the docking station to output second video data that is different from the first video data; and
a controller to selectively control the first video processing part or the second video processing part to output the first video data or the second video data, respectively, to the display part depending on whether the main body is docked on the docking station.

2. The computer system according to claim 1, wherein the controller controls the first video processing part to output the first video data to the display part when the main body is not docked on the docking station, and the second video processing part to output the second video data when the main body is docked on the docking station.

3. The computer system according to claim 1, further comprising a user input part to receive a selection of a user that selects one of the docking station and the main body, wherein the controller controls the first processing part to output the first video data from the main body, or the second processing part to output the second video data from the docking station to the display part, when the main body is docked on the docking station.

4. The computer system according to claim 1, wherein the second video data has a larger amount data per unit time than the first video data.

5. The computer system according to claim 1, wherein the display part is provided in the main body.

6. The computer system according to claim 1, wherein the display part is connected to the docking station.

7. A control method of a computer system including a main body, a docking station, and a display part, the method comprising:
checking whether the main body is docked on the docking station;
selectively processing first video data from the main body or second video data different from the first video data from the docking station, depending on a result of the checking; and
outputting the processed first video data or the processed second video data to the display part.

8. The control method according to claim 7, wherein the processing of the first video data or the second video data comprises processing the first video data when the main body is not docked on the docking station, and processing the second video data when the main body is docked on the docking station.

9. The control method according to claim 7, further comprising receiving a selection of the main body or the docking station when the main body is docked on the docking station, wherein the outputting of the processed first video data or the processed second video data comprises outputting the first video data from the selected main body or the second video data from the selected docking station to the display part.

10. The control method according to claim 7, wherein the second video data has a larger amount data per unit time than the first video data.

11. A computer system, including a main body, a docking station on which the main body is selectively docked, and a display part, comprising:
a first video processing part provided in the main body to process and to output first video data when in use;
a second video processing part provided in the docking station to process and to output second video data, the second video data including a larger amount of data per unit time than the first video data; and
a controller to automatically place the first video processing part in use when the main body is not docked on the docking station such that the first video data is outputted to and displayable by the display part and, when the main body is docked on the docking station, to automatically place the second video processing part in use such that the second video data is outputted to and displayable by the display part.

12. The computer according to claim 11, further comprising an input part by which a user inputs a selection of placing the first or the second video processing part in use when the main body is docked on the docking station, wherein the automatic placement of the second video processing part in use, when the main body is docked on the docking station, is overridden.

13. A control method of a computer system including a main body, a docking station on which the main body is selectively docked, and a display part, the method comprising:
determining whether the main body is docked on the docking station;
if the main body is not docked on the docking station, automatically arranging that a first video processing part of the main body outputs first video data to be displayable on the display part; and
if the main body is docked on the docking station, automatically arranging that a second video processing part of the docking station outputs second video data to be displayable on the display part.

14. The method according to claim 13, further comprising:
receiving a selection of a user to arrange that the first video processing part outputs the first video data to be displayable by the display part when the main body is docked on the docking station; and
arranging that the first video processing part of the main body outputs the first video data to be displayable on the display part in accordance with the selection.

15. The control method according to claim 14, wherein the arranging of the first video processing part of the main body to output the first video data to be displayable on the display part in accordance with the selection comprises overriding the automatic arranging of the second video processing part of the docking station to output the second video data to be displayable on the display part.

16. The control method according to claim 13, wherein the second video data has a larger amount data per unit time than the first video data.

17. A computer system, including a main body, a docking station on which the main body is selectively docked, and a display part, comprising:
a first video processing part provided in the main body to process and to output first video data when in use;
a second video processing part provided in the docking station to process and to output second video data, the second video data including a larger amount of data per unit time than the first video data; and
a controller to automatically place the first video processing part in use when the main body is not docked on the docking station such that the first video data is outputted to and displayable by the display part and, when the main body is docked on the docking station, to place one of the first or the second video processing part in use such that the corresponding first or second video data is outputted to and displayable by the display part.

18. A computer system, including a main body, a docking station on which the main body is selectively docked, and a display part, comprising:
a first video processing part provided in the main body to process and to output first video data when in use;
a second video processing part provided in the docking station to process and to output second video data, the second video data including a larger amount of data per unit time than the first video data; and
a controller to place the first video processing part in use when the main body is not docked on the docking station such that the first video data is outputted to and displayable by the display part and, when the main body is docked on the docking station, to place one of the first or the second video processing part in use, according to a received selection of a user, such that the corresponding first or second video data is outputted to and displayable by the display part.

19. A control method of a computer system including a main body, a docking station on which the main body is selectively docked, and a display part, the method comprising:
determining whether the main body is docked on the docking station;
if the main body is not docked on the docking station, automatically arranging that a first video processing part of the main body outputs first video data to be displayable on the display part; and
if the main body is docked on the docking station, arranging that one of the first or a second video processing part of the main body and docking station, respectively, outputs second video data to be displayable on the display part.

20. A control method of a computer system including a main body, a docking station on which the main body is selectively docked, and a display-part, the method comprising:
determining whether the main body is docked on the docking station;
if the main body is not docked on the docking station, automatically arranging that a first video processing part of the main body outputs first video data to be displayable on the display part; and
if the main body is docked on the docking station, arranging, according to a received selection of a user, that one of the first or a second video processing part of the main body and docking station, respectively, outputs second video data to be displayable on the display part.
